(19) United States
(12) Patent Application Publication
(10) Pub. No.: US 2016/0148455 A1
(43) Pub. Date: May 26, 2016

(54) BANKNOTE DISCRIMINATION DEVICE

(71) Applicant: OKI ELECTRIC INDUSTRY CO., LTD., Tokyo (JP)

(72) Inventors: Naoki HATA, Tokyo (JP); Nobuharu NISHINO, Tokyo (JP); Yukihiro NEMOTO, Tokyo (JP)

(73) Assignee: Oki Electric Industry Co., Ltd., Tokyo (JP)

(21) Appl. No.: 14/899,308

(22) PCT Filed: May 19, 2014
(86) PCT No.: PCT/JP2014/063236

§ 371 Date: Dec. 17, 2015

(30) Foreign Application Priority Data
Sep. 30, 2013 (JP) 2013-203244

(51) Int. Cl. G07D 7/04; G07D 7/12

(52) U.S. Cl. CPC G07D 7/04; G07D 7/121

(57) ABSTRACT

There is provided a banknote discrimination device including transport rollers (203), (204), (205), and (206) configured to transport a banknote, transport guides (217a) and (218a) configured to form a transport surface of the banknote, sensors (211), (212), (213), and (214) configured to detect data regarding the banknote, and glass integrated resin-molded units configured to include glasses (210g) (211g), (212g), and (213g) forming the transport surface of the banknote at a time of detection of the data and resin members (210m), (211m), (212m), and (213m) covering peripheries of the glasses (210g) (211g), (212g), and (213g). The resin members (210m), (211m), (212m), and (213m) included in the glass integrated resin-molded units and the transport guides (217a) and (218a) are molded to be integrated.

### TECHNICAL FIELD

The present invention relates to a banknote discrimination device.

### BACKGROUND ART

In the related art, banknote discrimination devices that are provided in automatic teller machines that are installed in financial institutes or the like and automatically perform banknote deposit and withdrawal processes through customer manipulations or cash processors that automatically perform banknote denomination classification or normal or damaged classification through defacement discrimination have been disclosed (for example, see JP H09-245217A). In the banknote discrimination devices, for example, reflective sensors detecting light reflected from banknotes as reflective images, transmissive sensors detecting transmitted light transmitted through banknotes as transmissive images, magnetic sensors detecting magnetic characteristics of banknotes, or thickness sensors detecting the thicknesses of banknotes are used as sensors determining denominations, normal or damaged states, authenticity, and the like of banknotes while the banknotes are transported.

For example, such sensors are provided on both sides (for example, an upper unit side and a lower unit side) of transported banknotes to face each other. Further, such sensors may be provided without protrusion or step differences so that the sensors do not obstruct flow of transported banknotes. Reflective sensors or transmissive sensors may be optically transparent and have transport surfaces that are strong against scratching, and it is proper to use optical glass as the transport surfaces of the reflective sensors or the transmissive sensors. For example, transport structures that are smooth without such protrusions or step differences are also disclosed (for example, see JP 2010-214589A).

### SUMMARY OF INVENTION

### Technical Problem

In such technologies, however, it is necessary to join the transport surfaces of the sensors in nesting shapes in order to provide sensors without protrusions or step differences. For this reason, for example, when there is a restriction on disposition of transport rollers, intervals of the rollers, and disposition of sensors, and nesting portions may not be densely structured, there is a problem of the ends of transported banknotes colliding against the nesting portions and being caught in the nesting portions.

Accordingly, the present invention is devised in view of the foregoing problem and an object of the present invention is to provide a banknote discrimination device capable of improving transport performance of banknotes.

### Solution to Problem

In order to solve the problem, according to an aspect of the present invention, there is provided a banknote discrimination device including: a transport roller configured to transport a banknote; a transport guide configured to form a transport surface of the banknote; a sensor configured to detect data regarding the banknote; and a glass integrated resin-molded unit configured to include a glass forming the transport surface of the banknote at a time of detection of the data and a resin member covering a periphery of the glass. The resin member included in the glass integrated resin-molded unit and the transport guide are molded to be integrated.

The resin member included in the glass integrated resin-molded unit and the transport guide may form a flat transport surface.

A joining portion of the resin member included in the glass integrated resin-molded unit and the transport guide may have a structure in which the resin member included in the glass integrated resin-molded unit and the transport guide are fitted.

A joining portion of the resin member included in the glass integrated resin-molded unit and the glass may have a structure in which the resin member included in the glass integrated resin-molded unit and the glass are fitted.

A white reference tape may be attached to an end of the glass and the sensor may include a holding portion covering the white reference tape.

The glass may include an optical glass through which light radiated to the banknote and light reflected from the banknote are transmitted and the sensor may include a reflective sensor that detects the reflected light transmitted through the optical glass.

The sensor may include an optical glass through which transmitted light transmitted through the banknote is transmitted and the glass may include a transmissive sensor that detects the transmitted light transmitted through the optical glass.

The banknote discrimination device may include: a magnetic sensor configured to detect magnetic information regarding the banknote. The magnetic sensor may include a resin member forming the transport surface of the banknote at a time of detection of the magnetic information, and the resin member forming the transport surface of the banknote and the transport guide may be molded to be integrated.

The resin member forming the transport surface of the banknote may be formed to be thinner than a thickness of the transport guide.

### Advantageous Effects of Invention

According to the present invention described above, it is possible to improve transport performance of banknotes.

### BRIEF DESCRIPTION OF DRAWINGS

FIG. 1 is a perspective view illustrating the outer appearance of an automatic teller machine according to a first embodiment.

FIG. 2 is a diagram illustrating an example of the configuration of a banknote deposit and withdrawal device according to the first embodiment.

FIG. 3 is a diagram illustrating an example of an internal configuration of a general banknote discrimination device when viewed from a side surface thereof.

FIG. 4 is a diagram illustrating an example of a transport surface when a lower unit is viewed from an arrow direction A of FIG. 3

FIG. 5 is a diagram illustrating an example of an internal configuration of a banknote discrimination device according to the first embodiment when viewed from a side surface thereof.

FIG. 6 is a diagram illustrating an example of a transport surface when a lower unit is viewed from an arrow direction B of FIG. 5.

FIG. 7 is a diagram illustrating an example of the configuration of a glass integrated resin-molded unit according to the first embodiment.

FIG. 8 is a diagram illustrating an example of the configuration of a glass integrated resin-molded unit according to a second embodiment.

FIG. 9A is a diagram illustrating an example of the configuration of a glass integrated resin-molded unit according to a third embodiment.

FIG. 9B is a diagram illustrating an example of the configuration of the glass integrated resin-molded unit according to the third embodiment.

FIG. 10 is a diagram illustrating an example of a transport surface of a magnetic sensor according to a fourth embodiment.

### DESCRIPTION OF EMBODIMENTS

Hereinafter, referring to the appended drawings, preferred embodiments of the present invention will be described in detail. It should be noted that, in the present description and the appended drawings, structural elements that have substantially the same function and structure are denoted with the same reference numerals, and repeated explanation thereof is omitted.

Note that, in the present description and the drawings, structural elements that have substantially the same function and structure are sometimes distinguished from each other using different alphabets or numerals after the same reference sign. However, when there is no need in particular to distinguish structural elements that have substantially the same function and structure, the same reference sign alone is attached.

### Description of First Embodiment

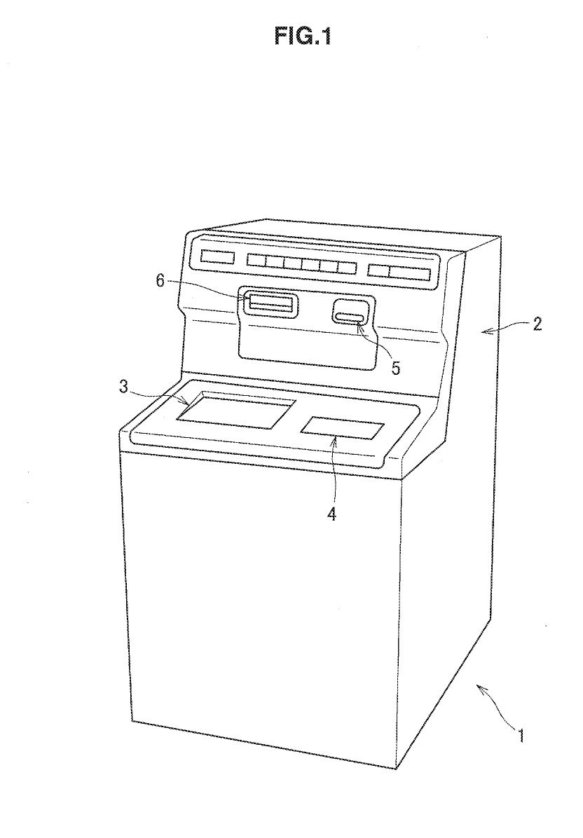

First, a first embodiment of the present invention will be described. FIG. 1 is a perspective view illustrating the outer appearance of an automatic teller machine 1 according to the first embodiment. As illustrated in FIG. 1, the automatic teller machine 1 according to the first embodiment includes, for example, a casing 2, a display 3, a deposit and withdrawal port 4, a card insertion and return port 5, and a bankbook insertion and return port 6. In the following description, an example in which each mechanism unit is received in the automatic teller machine 1 will be described, but each mechanism unit may be received in another terminal (for example, a cash processor) instead of the automatic teller machine 1.

Mechanism units such as a card reader and printer, a banknote deposit and withdrawal device, a banknote discrimination device, denomination classification storages, a temporary reservation part, and a reject storage are received in the casing 2. The display 3 serves as both of a touch sensor which is an input unit in which direct contact on a display screen is possible for a manipulation and a display unit which displays a manipulation portion and the like. As illustrated in FIG. 1, the display 3 may be provided in an upper portion of the front side of the casing 2, but the position at which the display 3 is provided is not particularly limited.

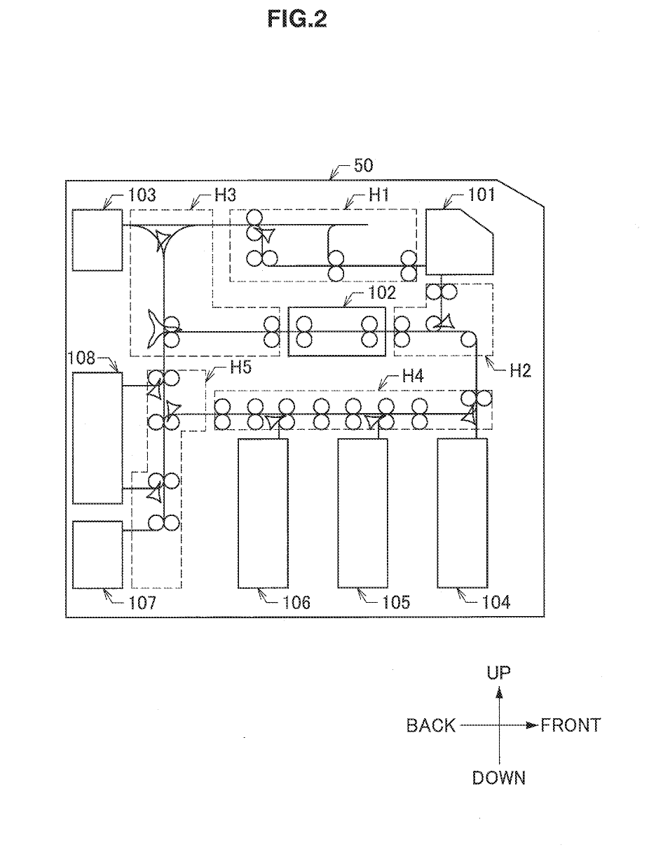

FIG. 2 is a diagram illustrating an example of the configuration of a banknote deposit and withdrawal device 50 according to the first embodiment. Banknotes input from the deposit and withdrawal port 4 can be collected in a service port 101 of the banknote deposit and withdrawal device 50. The banknote deposit and withdrawal device 50 includes the reception port 101 into or from which a customer deposits or withdraws banknotes, a banknote discrimination device 102 that discriminates whether the banknotes to be deposited or withdrawn are acceptable, and a temporary reservation unit 103 that reserves the deposited banknotes.

The banknote deposit and withdrawal device 50 also includes denomination classification storages 104, 105, and 106 that store deposited banknotes or banknotes for withdrawal and a reject storage 107 that stores banknotes discriminated as unacceptable banknotes. The banknote deposit and withdrawal device 50 also includes a supplement and recovery cassette 108 for supplementing banknotes for withdrawal to the denomination classification storages 104, 105, and 106 and recovering banknotes for withdrawal from the denomination classification storages 104, 105, and 106. The banknote deposit and withdrawal device 50 also includes transport units H1, H2, H3, H4, and H5 that transport banknotes to these units. Various other mechanisms for controlling transport of banknotes are provided in the banknote deposit and withdrawal device 50, but are not illustrated to facilitate the description herein.

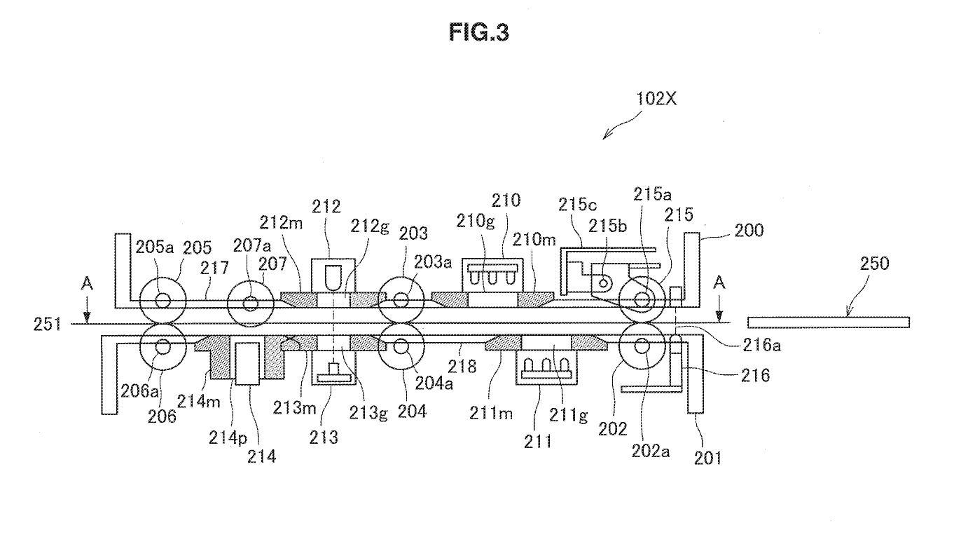

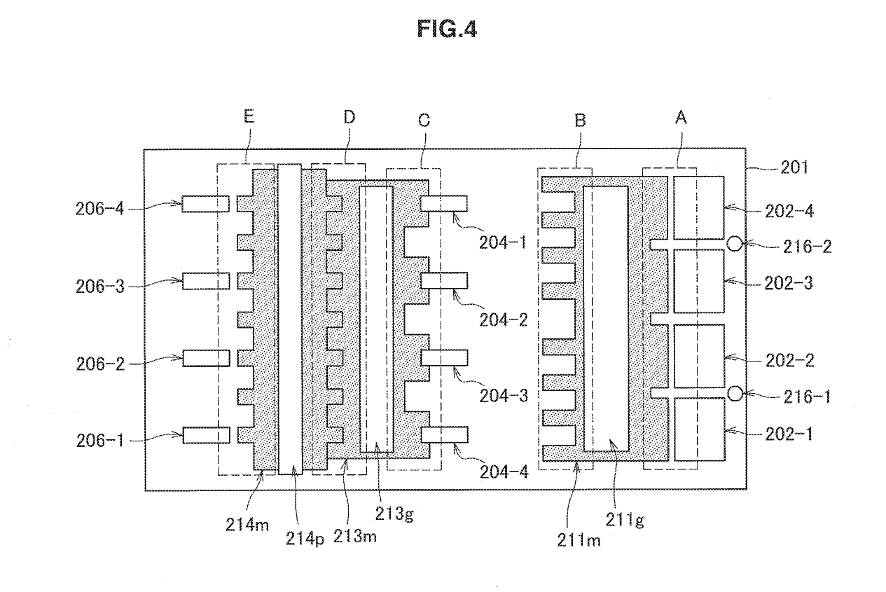

A general banknote discrimination device 102X will be described to clarify differences between a technology according to the embodiment and a general technology. FIG. 3 is a diagram illustrating an example of an internal configuration of the general banknote discrimination device 102X when viewed from a side surface thereof. FIG. 4 is a diagram illustrating an example of a transport surface when a lower unit 201 is viewed from an arrow direction A of FIG. 3. As illustrated in FIG. 3, the banknote discrimination device 102X includes a transport path 251 between an upper unit 200 and a lower unit 201.

The banknote discrimination device 102X includes an optical glass 210g through which light radiated to a banknote passing along the transport path 251 in a reflective sensor 210 of the upper unit 200 and light reflected from the banknote are transmitted. A resin transport unit 210m that forms a smooth surface along with the transport surface of the optical glass 210g is fitted in a transport guide 217 of the upper unit 200. The banknote discrimination device 102X includes an optical glass 211g through which light radiated to a banknote passing along the transport path 251 in a reflective sensor 211 of the lower unit 201 and light reflected from the banknote are transmitted. A resin transport unit 211m that forms a smooth surface along with the transport surface of the optical glass 211g is fitted in a transport guide 218 of the lower unit 201.

As illustrated in FIG. 4, the resin transport unit 211m has a nesting shape as in an A portion and a B portion and forms a comb shape along with the transport surface of the lower unit 201. In this configuration, it is possible to prevent a banknote 250 passing along the transport path 251 from penetrating into a boundary of the transport surface of the lower unit 201 and the reflective sensor 211. The resin transport unit 210m also has the same nesting shape and forms a comb shape along with the transport surface of the upper unit 200. In this configuration, it is possible to prevent the banknote 250 passing along the transport path 251 from penetrating into a boundary of the transport surface of the upper unit 200 and the reflective sensor 210.

The banknote discrimination device 102X includes an optical glass 212g through which light radiated to a banknote passing along the transport path 251 in a transmissive sensor light-emitting unit 212 of the upper unit 200 is transmitted. A resin transport unit 212m that forms a smooth surface along with the transport surface of the optical glass 212g is fitted in a transport guide 217 of the upper unit 200. The radiated light is radiated by the transmissive sensor light-emitting unit 212. The banknote discrimination device 102X includes an optical glass 213g through which transmitted light transmitted through a banknote passing along the transport path 251 in a transmissive sensor light-receiving unit 213 of the lower unit 201 is transmitted. A resin transport unit 213m that forms a smooth surface along with the transport surface of the optical glass 213g is fitted in the transport guide 218 of the lower unit 201.

The resin transport unit 212m has the same nesting shape and forms a comb shape along with the transport surface of the upper unit 200. In this configuration, it is possible to prevent a banknote 250 passing along the transport path 251 from penetrating into a boundary of the transport surface of the upper unit 200 and the transmissive sensor light-emitting unit 212. As illustrated in FIG. 4, the resin transport unit 213m also has a nesting shape as in a C portion and a D portion and forms a comb shape along with the transport surface of the lower unit 201. In this configuration, it is possible to prevent the banknote 250 passing along the transport path 251 from penetrating into a boundary of the transport surface of the lower unit 201 and the transmissive sensor light-receiving unit 213.

The banknote discrimination device 102X includes a magnetic sensor 214 that detects magnetic characteristics of a banknote passing through the transport path in the lower unit 201. The magnetic sensor 214 is covered with a metal cover 214p (for example, a nonmagnetic thin plate of about 0.2 mm) forming a smooth surface along with a resin transport unit 214m. The resin transport unit 214m is fitted in the transport guide 218 of the lower unit 201. As illustrated in FIG. 4, the resin transport unit 214m has a nesting shape as in an E portion and forms a comb shape along with the transport surface of the lower unit 201. In this configuration, it is possible to prevent the banknote 250 passing along the transport path 251 from penetrating into a boundary of the transport surface of the lower unit 201 and the magnetic sensor 214.

In the general banknote discrimination device 102X described above, it is necessary to join the transport surfaces of the sensors in a nesting shape. For this reason, for example, when there is restriction on disposition of transport rollers, intervals of the rollers, and disposition of sensors, and nesting portions may not be densely structured, there is a problem of the end of the transported banknote 250 colliding against the nesting portions and being caught in the nesting portions. In the present specification, the banknote discrimination device 102 capable of improving transport performance of the banknote 250 by forming the transport surfaces of the banknote 250 as a seamless integrated smooth surface so that the nesting shape is not necessary will be proposed.

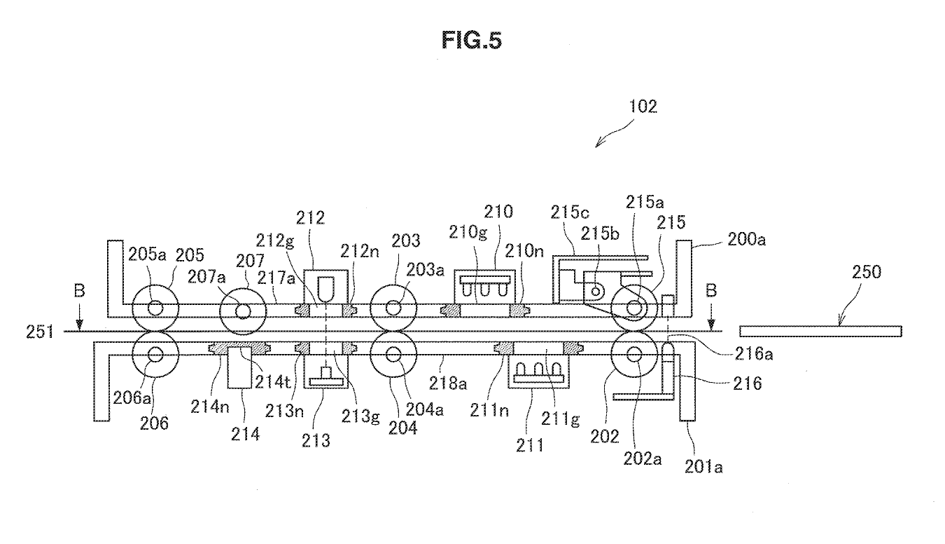

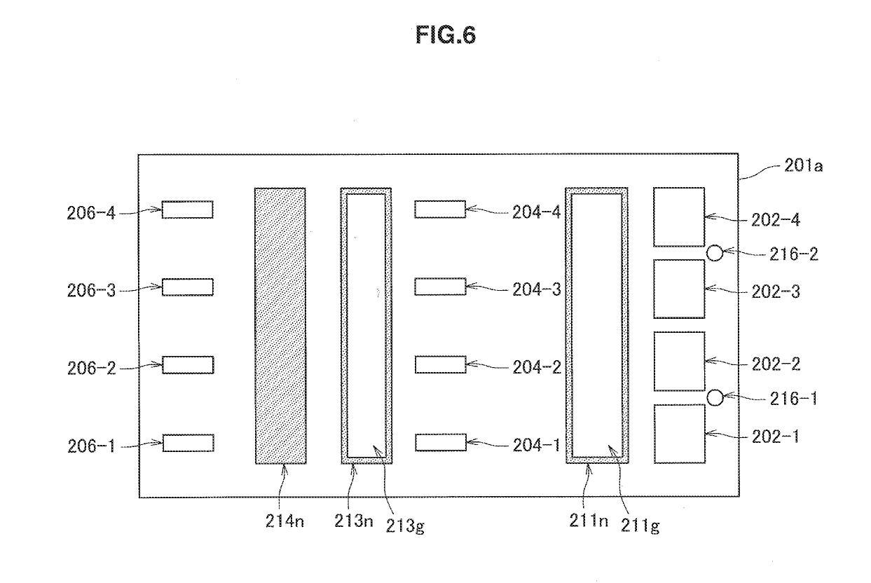

FIG. 5 is a diagram illustrating an example of an internal configuration of the banknote discrimination device 102 according to the first embodiment when viewed from a side surface thereof. FIG. 6 is a diagram illustrating an example of a transport surface when a lower unit 201a is viewed from an arrow direction B of FIG. 5. As illustrated in FIG. 5, the banknote discrimination device 102 includes the transport path 251 between an upper unit 200a and a lower unit 200b. A transport roller 203 is fitted in the upper unit 200a to be rotatable about a shaft 203a. A transport roller 205 is fitted on the upper unit 200a to be rotatable about a shaft 205a.

A transport roller 204 facing the transport roller 203 with the transport path 251 interposed therebetween is fitted in the lower unit 201a to be rotatable about a shaft 204a. A transport roller 206 facing the transport roller 205 with the transport path 251 interposed therebetween is fitted in the lower unit 201a to be rotatable about a shaft 206a. The transport rollers 203, 204, 205, and 206 transport the banknote 250 passing along the transport path 251.

A thickness detection roller 215 is supported by a roller support bracket 215a to be rotatable, and the roller support bracket 215a is supported to be rotatable about a shaft 215b and fitted in a bracket 215c fixed to the upper unit 200a. A roller 202 facing the thickness detection roller 215 with the transport path 251 interposed therebetween includes a shaft 202a and is fitted in the lower unit 201a.

The upper unit 200a includes a transport guide 217a that forms a transport surface of the banknote 250 and the lower unit 201a includes a transport guide 218a that forms a transport surface of the banknote 250. A sensor that detects data regarding the banknote 250 is provided in at least one of the transport guides 217a and 218a. The data detected by the sensor can be used to determine the denomination, a normal or damaged state, authenticity, and the like of the banknote 250.

Referring to the example illustrated in FIG. 5, the reflective sensor 210 and the transmissive sensor light-emitting unit 212 are provided in the transport guide 217a. The reflective sensor 211, the transmissive sensor light-receiving unit 213, and the magnetic sensor 214 are provided in the transport guide 218a. A roller 207 is fitted in a shaft 207a to face the magnetic sensor 214 with a slight gap therebetween and is fitted in the lower unit 201a to be rotatable.

The reflective sensor 210 radiates light to the banknote 250 passing along the transport path 251 and detects light reflected from the banknote 250 as data regarding the banknote. The reflective sensor 210 includes a glass integrated resin-molded unit including a glass that forms the transport surface of the banknote 250 at the time of detection of data and a resin member 210n that covers the periphery of the glass. As illustrated in FIG. 5, when the glass is configured as the optical glass 210g, the optical glass 210g transmits light radiated to the banknote 250 and light reflected from the banknote 250. At this time, the reflective sensor 210 detects the reflected light transmitted through the optical glass 210g. More specifically, the reflective sensor 210 detects the reflected light transmitted through the optical glass 210g and reflected from the banknote 250 when the radiated light transmitted through the optical glass 210g reaches the banknote 250 and is reflected. The resin member 210n included in the glass integrated resin-molded unit and the transport guide 217a are molded to be integrated. Further, the resin member 210n included in the glass integrated resin-molded unit and the transport guide 217a form a flat transport surface.

The reflective sensor 211 radiates light to the banknote 250 passing along the transport path 251 and detects light reflected from the banknote 250 as data regarding the banknote. The reflective sensor 210 includes a glass integrated resin-molded unit including a glass that forms the transport surface of the banknote 250 at the time of detection of data and a resin member 211n that covers the periphery of the glass. As illustrated in FIG. 5, when the glass is configured as the optical glass 211g, the optical glass 211g transmits light radiated to the banknote 250 and light reflected from the banknote 250. At this time, the reflective sensor 211 detects the reflected light transmitted through the optical glass 211g. More specifically, the reflective sensor 211 detects the light reflected from the banknote 250 transmitted through the optical glass 211g when the radiated light transmitted through the optical glass 211g reaches the banknote 250 and is reflected. The resin member 211n included in the glass integrated resin-molded unit and the transport guide 218a are molded to be integrated. Further, the resin member 211n included in the glass integrated resin-molded unit and the transport guide 218a form a flat transport surface.

The transmissive sensor light-emitting unit 212 radiates light to the banknote 250 passing along the transport path 251 and the transmissive sensor light-receiving unit 213 detects light transmitted through the banknote 250 as data regarding the banknote. As illustrated in FIG. 5, when the glass is configured as the optical glass 212g, the optical glass 212g transmits the light radiated to the banknote 250. The transmissive sensor light-emitting unit 212 includes a glass integrated resin-molded unit including a glass that forms the transport surface of the banknote 250 at the time of detection of data and a resin member 212n that covers the periphery of the glass. The resin member 212n included in the glass integrated resin-molded unit and the transport guide 217a are molded to be integrated. Further, the resin member 212n included in the glass integrated resin-molded unit and the transport guide 217a form a flat transport surface.

The transmissive sensor light-receiving unit 213 includes a glass integrated resin-molded unit including a glass that forms the transport surface of the banknote 250 at the time of detection of data and a resin member 213n that covers the periphery of the glass. As illustrated in FIG. 5, when the glass is configured as the optical glass 213g, the optical glass 213g transmits transmitted light from the banknote 250. At this time, the transmissive sensor light-receiving unit 213 detects the transmitted light transmitted through the optical glass 213g. More specifically, the transmissive sensor light-receiving unit 213 detects the transmitted light when the radiated light radiated from the transmissive sensor light-emitting unit 212 and transmitted through the optical glass 212g is transmitted through the banknote 250 and the optical glass 213g. The resin member 213n included in the glass integrated resin-molded unit and the transport guide 218a are molded to be integrated. Further, the resin member 213n included in the glass integrated resin-molded unit and the transport guide 218a form a flat transport surface.

The magnetic sensor 214 detects magnetic information regarding the banknote 250 passing along the transport path 251 as data regarding the banknote. More specifically, since ink used to print the banknote 250 has magnetism, the magnetic sensor 214 detects the magnetic characteristics of the ink as the magnetic information. The magnetic sensor 214 includes a resin member 214n forming the transport surface of the banknote 250 at the time of the detection of the magnetic information. The resin member 214n and the transport guide 218a are molded to be integrated. The resin member 214n and the transport guide 218a form a flat transport surface.

The transport guides were manufactured using an inexpensive resin with excellent shock resistance or abrasion resistance, such as modified polyphenylene ether, an ABS resin, or polycarbonate, and molding and integrating of the optical glass and the peripheral resin was examined. However, a phenomenon in which the optical glass of which the shape changes less at a low temperature was warped due to contraction of the peripheral resin and cracking occurred was confirmed.

Accordingly, the resin member 211n may be molded to be integrated with the optical glass 211g of the reflective sensor 211 by using a thermoplastic resin material such as a liquid crystal polymer in which a linear expansion coefficient indicating an expansion rate by heat is low and which can be filled in a molding die even at a low pressure and has high fluidity. For the same reasons, the resin member 213n may be molded to be integrated with the optical glass 213g of the transmissive sensor light-receiving unit 213 using a thermoplastic resin material. Thus, it is possible to reduce a possibility of occurrence of a phenomenon in which the optical glass is warped due to contraction of the resin and cracking occurs.

Next, an operation of the automatic teller machine 1 according to the first embodiment will be described. The banknote 250 input from the deposit and withdrawal port 4 of the automatic teller machine 1 (or the banknote 250 taken out from the supplement and recovery cassette 108 or the denomination classification storage 104, 105, or 106 in the banknote deposit and withdrawal device 50) by a customer is transported to the banknote discrimination device 102 along each transport path. Next, the banknote discrimination device 102 draws the transported banknote 250 to the transport path of the banknote discrimination device 102 by rotating the rollers 202 and 207 and the transport rollers 204 and 206 by a rotation driving mechanism (not illustrated). Next, the banknote discrimination device 102 sends out the banknote 250 while the various sensors provided in the transport guide 217a of the upper unit 200a and the transport guide 218a of the lower unit 201a detect the data regarding the banknote.

As described above, in the first embodiment, the sensors include the glass integrated resin-molded units, and the resin members included in the glass integrated resin-molded units and the transport guides are molded to be integrated. In this configuration, it is possible to improve the transport performance of the banknote. Specifically, in this configuration, it is not necessary to include a nesting portion in the transport surface. Therefore, it is possible to obtain advantages of resolving step differences which are transport obstacles of the banknote 250 and suppressing transport jamming in which a folded portion of the banknote 250 is caught in the step differences.

When a resin with high fluidity such as a liquid crystal polymer in the transport path along which the banknote 250 is transported is used as a main material of the transport guides, there is disadvantage in terms of cost. Therefore, for the transport guides, it is proper to use a resin in which many additives such glass fillers are mixed and which is advantageous in terms of cost. For example, of resin molding materials, a thermoplastic resin material such as a liquid crystal polymer with a low linear expansion coefficient may be molded to be integrated as a resin member in the periphery of the optical glass with the transport guide. Thus, it is possible to obtain the advantage of alleviating a shape change caused due to a difference in the linear expansion coefficient which occurs between the transport guide and the optical glass due to a temperature change in the internal activation environment of the banknote deposit and withdrawal device 50, and thus it is possible to prevent a warped state or cracking of the optical glass.

The first embodiment of the present invention has been described above.

### Description of Second Embodiment

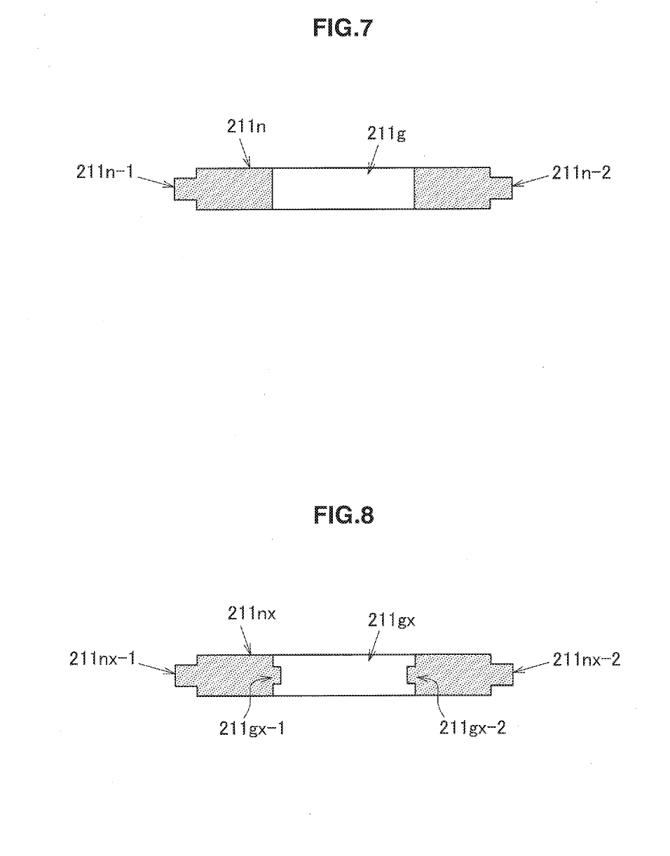

Next, a second embodiment of the present invention will be described. The second embodiment of the present invention is different from the first embodiment of the present invention in the configuration of the glass integrated resin-molded unit. Thus, in the second embodiment of the present invention, the configuration of the glass integrated resin-molded unit will be mainly described. FIG. 7 is a diagram illustrating an example of the configuration of a glass-integrated resin molded unit according to the first embodiment. FIG. 8 is a diagram illustrating an example of the configuration of the glass-integrated resin molded unit according to the second embodiment. Here, the glass integrated resin-molded unit of the reflective sensor 211 will be mainly described, but a kind of sensor is not limited to the reflective sensor 211.

Referring to FIG. 7, the glass integrated resin-molded unit according to the first embodiment of the present invention includes the optical glass 211g and the resin member 211n covering the periphery of the optical glass 211g. A joining portion of the resin member 211n and the transport guide 218a has a structure in which the resin member 211n and the transport guide 218a are fitted. Specifically, the resin member 211n includes convex portions 211n-1 and 211n-2. The convex portions 211n-1 and 211n-2 have a structure fitted to a concave portion of the transport guide 218a. However, there is no structure in which the optical glass 211g and the resin member 211n are fitted.

On the other hand, referring to FIG. 8, similarly, the glass integrated resin-molded unit according to the second embodiment of the present invention includes an optical glass 211gx and a resin member 211nx covering the periphery of the optical glass 211gx. A joining portion of the resin member 211nx and the transport guide 218a have a structure in which the resin member 211nx and the transport guide 218a are fitted. Specifically, the resin member 211nx includes convex portions 211nx-1 and 211nx-2. The convex portions 211nx-1 and 211nx-2 have a structure fitted in a concave portion of the transport guide 218a.

In the second embodiment of the present invention, the joining portion of the resin member 211nx and the optical glass 211gx has a structure in which the resin member 211nx and the optical glass 211gx are fitted. Specifically, the resin member 211nx has convex portions, and convex portions 211gx-1 and 211gx-2 have a structure fitted in concave portions 211gx-1 and 211gx-2 of the optical glass 211gx. In a molding process, the concave portions 211gx-1 and 211gx-2 are formed in the optical glass 211gx, and then the resin member 211nx and the optical glass 211gx are molded to be integrated.

In this configuration, it is possible to further improve a joining strength of the optical glass 211gx and the resin member 211nx. In this configuration, the sealing property of the reflective sensor 211 is further improved. Thus, for example, it is possible to prevent particles such as sheet dust from being mixed inside the sensor. When data regarding the banknote is detected, it is possible to prevent optical detection performance from deteriorating.

The second embodiment of the present invention has been described above.

### Description of Third Embodiment

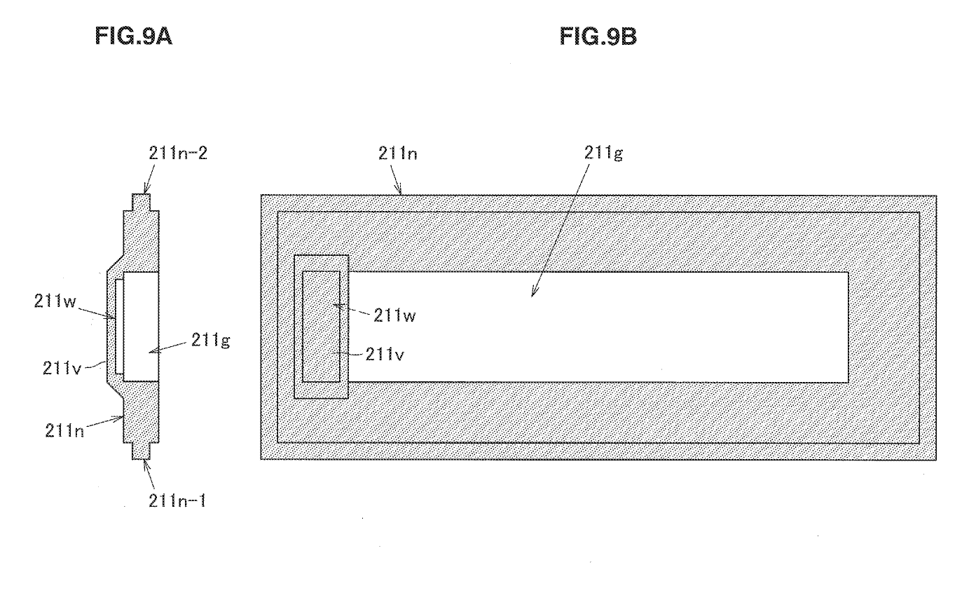

Next, a third embodiment of the present invention will be described. The third embodiment of the present invention is different from the first embodiment of the present invention in the configuration of the glass integrated resin-molded unit. Thus, in the third embodiment of the present invention, the configuration of the glass integrated resin-molded unit will be mainly described. FIGS. 9A and 9B are diagrams illustrating an example of the configuration of a glass-integrated resin molded unit according to the third embodiment. Here, the glass integrated resin-molded unit of the reflective sensor 211 will be mainly described, but a kind of sensor is not limited to the reflective sensor 211.

Referring to FIGS. 9A and 9B, a white reference tape 211w is attached to an end (for example, one side at an end of the optical glass 211g in a longitudinal direction) of the optical glass 211g in the third embodiment of the present invention. The reflective sensor 211 includes a holding portion 211v covering the white reference tape 211w. In a molding process, the white reference tape 211w is attached to the optical glass 211g, and then the resin member 211n and the optical glass 211g are molded to be integrated. For example, as illustrated in FIG. 9A, an end of the holding portion 211v may be inclined.

In this configuration, the white reference tape 211w can be configured not to be exposed in the transport surface. In this configuration, the white reference tape 211w is stuck from the side of the transport surface and an overcoat process of separately applying a layer for preventing abrasion or dirt adhesion can be omitted. Therefore, it is possible to shorten a working time and improve manufacturing efficiency.

The third embodiment of the present invention has been described above.

### Description of Fourth Embodiment

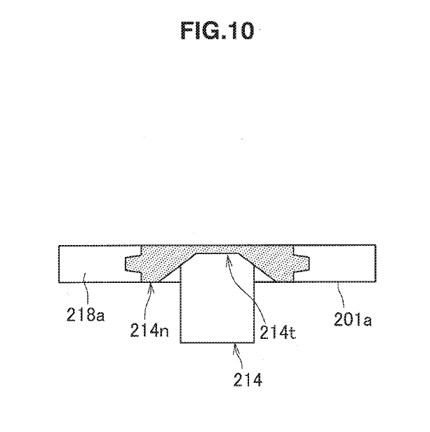

Next, a fourth embodiment of the present invention will be described. The fourth embodiment of the present invention is different from the first embodiment of the present invention in the configuration of the magnetic sensor 214. Thus, in the fourth embodiment of the present invention, the configuration of the magnetic sensor 214 will be mainly described. FIG. 10 is a diagram illustrating an example of a transport surface of the magnetic sensor 214 according to the fourth embodiment.

As described above, magnetic sensor 214 detects the magnetic characteristics of the ink used to print the banknote 250. Accordingly, an internal element of the magnetic sensor 214 may approach the transport surface of the resin member 214n so that the magnetic characteristics of the ink are easily detected. Specifically, as illustrated in FIG. 10, the resin member 214n of the magnetic sensor 214 may include a thin portion 214t formed thinner than the thickness of the transport guide 218a. By doing so, the magnetic sensor may be fitted directly in the thin portion 214t. Therefore, since the metal cover 214p may not be provided, a reduction in the number of components and shortening of an assembly order are realized.

To mold such a thin portion 214t, it is proper to use a resin material with high fluidity (for example, a liquid crystal polymer with high fluidity) as the thin portion 214t. That is, of the kinds of resins that form the resin member 214n, at least one kind of resin may be a resin material with high fluidity. The thickness of the thin portion 214t may be in the range of, for example, 0.2 mm to 0.5 mm. When a resin material with high fluidity is used as the thin portion 214t, the thickness of the thin portion 214t can also be set to be in the range of 0.2 mm to 0.5 mm.

In this configuration, height adjustment work for the transport guide 218a in which the magnetic sensor 214 is disposed can be omitted, and thus efficiency in manufacturing can be realized. Further, the resin member 214n includes the thin portion 214t, and thus the distance between the magnetic sensor 214 and the transport path 251 can be narrowed. Thus, a detection range of the magnetic characteristics can be broadened.

As described above, of the kinds of resins that form the resin member 214n, at least one kind of resin may be a resin material with high fluidity. However, the resin member 214n may be molded to be integrated with the thin portion 214t and the other portions by two or more different kinds of materials. Accordingly, it is possible to resolve transport failure due to collision of a banknote against a step difference. Since the resin material with high fluidity is often expensive, it is possible to obtain the advantage of reducing the cost by suppressing a necessary amount of resin material with high fluidity.

The fourth embodiment of the present invention has been described above.

### Description of Modification Examples

Preferred embodiments of the present invention have been described in detail above with reference to the appended drawings, but the present invention is not limited to these examples. It should be apparent to those skilled in the art in the technical field to which the present invention pertains that various modification examples and correction examples can be made within the scope of the technical spirit and essence described in the claims and the modification examples and the correction examples are, of course, within the technical scope of the present invention.

For example, in the second embodiment, the technology for realizing both of the improvement in the joining strength with the resin member and guarantee of the sealing property by providing the concave portions in the ends of the optical glass has been described. However, a plurality of hole-shaped portions may be formed at the ends of the optical glass, and then the optical glass and the resin member may be molded to be integrated. Even when the plurality of hole-shaped portions are formed in the optical glass, it is possible to realize both of the improvement in the joining strength with the resin member and guarantee of the sealing property.

1. A banknote discrimination device comprising:
a transport roller configured to transport a banknote;
a transport guide configured to form a transport surface of the banknote;
a sensor configured to detect data regarding the banknote; and
a glass integrated resin-molded unit configured to include a glass forming the transport surface of the banknote at a time of detection of the data and a resin member covering a periphery of the glass,
wherein the resin member included in the glass integrated resin-molded unit and the transport guide are molded to be integrated.

2. The banknote discrimination device according to claim 1,
wherein the resin member included in the glass integrated resin-molded unit and the transport guide form a flat transport surface.

3. The banknote discrimination device according to claim 1,
wherein a joining portion of the resin member included in the glass integrated resin-molded unit and the transport guide has a structure in which the resin member included in the glass integrated resin-molded unit and the transport guide are fitted.

4. The banknote discrimination device according to claim 1,
wherein a joining portion of the resin member included in the glass integrated resin-molded unit and the glass has a structure in which the resin member included in the glass integrated resin-molded unit and the glass are fitted.

5. The banknote discrimination device according to claim 1,
wherein a white reference tape is attached to an end of the glass and the sensor includes a holding portion covering the white reference tape.

6. The banknote discrimination device according to claim 1,
wherein the glass includes an optical glass through which light radiated to the banknote and light reflected from the banknote are transmitted and the sensor includes a reflective sensor that detects the reflected light transmitted through the optical glass.

7. The banknote discrimination device according to claim 1,
wherein the sensor includes an optical glass through which transmitted light transmitted through the banknote is transmitted and the glass includes a transmissive sensor that detects the transmitted light transmitted through the optical glass.

8. The banknote discrimination device according to claim 1, comprising:
a magnetic sensor configured to detect magnetic information regarding the banknote,
wherein the magnetic sensor includes a resin member forming the transport surface of the banknote at a time of detection of the magnetic information, and the resin member forming the transport surface of the banknote and the transport guide are molded to be integrated.

9. The banknote discrimination device according to claim 8,
wherein the resin member forming the transport surface of the banknote is formed to be thinner than a thickness of the transport guide.
